(19) United States
(12) Patent Application Publication
(10) Pub. No.: US 2017/0003848 A1
(43) Pub. Date: Jan. 5, 2017

(54) MAP DISPLAY DEVICE AND MAP DISPLAY METHOD

(71) Applicant: MITSUBISHI ELECTRIC CORPORATION, Tokyo (JP)

(72) Inventors: Haruhiko WAKAYANAGI, Tokyo (JP); Mitsuo SHIMOTANI, Tokyo (JP)

(73) Assignee: Mitsubishi Electric Corporation, Tokyo (JP)

(21) Appl. No.: 14/901,670

(22) PCT Filed: Oct. 21, 2013
(86) PCT No.: PCT/JP2013/078428

§ 371 Date: Dec. 28, 2015

(51) Int. Cl. G06F 3/0485; G01C 21/36; B60K 35/00; G06F 3/0481

(52) U.S. Cl. CPC G06F 3/0485; G06F 3/04817; G06F 3/04812; G01C 21/3667; B60K 35/00; G06F 3/04883

(57) ABSTRACT

A map display device includes a map display unit that causes a touch panel to display a map, and a scrolling-screen display unit that causes the touch panel to display a scrolling screen that includes a direction designation region for a user to designate a direction to scroll the map. The center of the direction designation region corresponds to a reference point defined on the map being displayed on the touch panel. The scrolling-screen display unit causes a significant-object icon that indicates the existence or absence of a predetermined significant object in each direction viewed from the reference point to be displayed on the outer periphery of the direction designation region at a position corresponding to the direction.

### TECHNICAL FIELD

The present invention relates to a map display device having a function of scrolling a map display.

### BACKGROUND ART

Map display devices having a function of scrolling a map displayed on a screen have conventionally been known. Patent Document 1 below, for example, discloses a technique in which when a point displayed on the screen moves from the land to the sea while a user is scrolling a map with a scroll switch, a reaction force is applied to the scroll switch. This notifies the user that the displayed point has reached the sea, saving the user unnecessary scrolling.

Patent Document 2 discloses a technique in which a screen for a user to designate, with a single touch, the direction and distance for scrolling a map is displayed superimposed on the map. Patent Document 2 also discloses displaying the positions of points of interest (POIs) on the screen.

### PRIOR ART DOCUMENTS

### Patent Documents

[Patent Document 1] Japanese Patent Application Laid-Open No. 2005-181572

[Patent Document 2] Japanese Patent Application Laid-Open No. 2013-61210

### SUMMARY OF INVENTION

### Problems to be Solved by the Invention

The technique of Patent Document 1 notifies the user after the fact that the displayed point has reached the sea, and does not notify the user in advance that the sea lies in the direction of scrolling the map.

In Patent Document 2, POIs are displayed on the screen that is for designating the direction and distance for scrolling the map, and this allows the user to know in advance the types of facilities that will appear on the map after scrolling. In Patent Document 2, the screen for designating the direction and distance for scrolling the map is configured to concentrically display a plurality of circles, each indicating the distance from a central point on the map being displayed, and with this configuration, the existence of facilities located beyond the distance indicated by the outermost circle cannot be known.

The present invention has been achieved in order to solve such problems, and it is an object of the present invention to provide a map display device with a user-friendly map scrolling function that saves a user unnecessary scrolling.

### Means for Solving Problems

A map display device according to the present invention includes a map display unit that causes a display device to display a map, and a scrolling-screen display unit that causes the display device to display a scrolling screen that includes a direction designation region for a user to designate a direction of scrolling the map. The map display unit causes the map being displayed to scroll in the direction designated by the user using the scrolling screen, a center of the direction designation region corresponds to a reference point defined on the map being displayed on the display device, and the scrolling-screen display unit causes an icon that indicates existence or absence of a predetermined significant object in each direction viewed from the reference point to be displayed on an outer periphery of the direction designation region at a position corresponding to the direction.

### Advantageous Effects of the Invention

The map display device of the present invention allows the user, when scrolling a map, to know in advance the existence or absence of significant objects in each direction, thus saving the user unnecessary scrolling.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram of a configuration of a map display device according to Embodiment 1;

FIG. 2 illustrates an example of a map displayed on a touch panel;

FIG. 3 illustrates a configuration of a scrolling screen according to Embodiment 1;

FIG. 4 illustrates an example of display on the touch panel that displays the scrolling screen superimposed on the map;

FIG. 5 is a flowchart of operations performed by the map display device according to Embodiment 1;

FIG. 6 illustrates a configuration of a direction designation region on the scrolling screen according to a variation of Embodiment 1;

FIG. 7 illustrates a configuration of the direction designation region on the scrolling screen according to a variation of Embodiment 1;

FIG. 8 illustrates a configuration of the direction designation region on the scrolling screen according to a variation of Embodiment 1;

FIG. 9 illustrates a configuration of the direction designation region on the scrolling screen according to a variation of Embodiment 1;

FIG. 10 illustrates a configuration of the direction designation region on the scrolling screen according to Embodiment 2;

FIG. 11 illustrates a configuration of the direction designation region on the scrolling screen according to Embodiment 3;

FIG. 12 illustrates a configuration of the direction designation region on the scrolling screen according to Embodiment 3;

FIG. 13 illustrates a configuration of the direction designation region on the scrolling screen according to Embodiment 4; and

FIG. 14 illustrates a configuration of the direction designation region on the scrolling screen according to Embodiment 4.

### DESCRIPTION OF EMBODIMENTS

### Embodiment 1

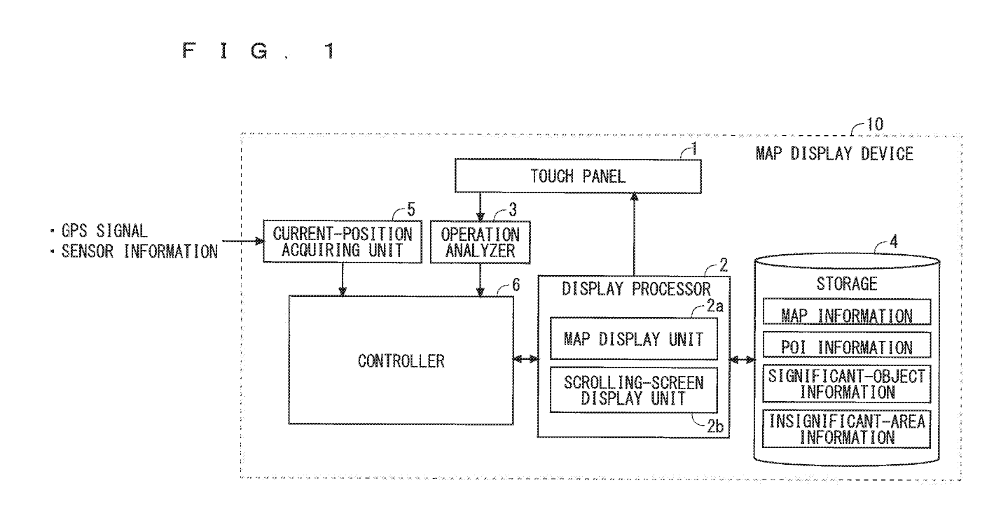

FIG. 1 is a block diagram of a configuration of a map display device 10 according to Embodiment 1. The map display device 10 includes a touch panel 1, a display processor 2, an operation analyzer 3, a storage 4, a current-position acquiring unit 5, and a controller 6 that controls operations performed by these units. The map display device 10 is configured using a computer, and the display processor 2, the operation analyzer 3, the current-position acquiring unit 5, and the controller 6 are implemented by the computer operating in accordance with programs. The storage 4 is configured by a storage medium such as a hard disk, a removable disk, or a memory.

The touch panel 1 is an input/output device configured by integrating a display device such as a liquid crystal panel with a touch pad (operation input device). That is, the touch panel 1 has a function serving as a display device that displays images, and a function serving as an operation input device that receives user operations (touch operations) performed on the screen. Examples of the touch operations performed on the touch panel 1 include “tap” which involves tapping the screen with a finger, “drag” which involves moving a finger touching on the screen, and “flick” which involves flicking a finger across the screen. The present embodiment takes the example of the case where the touch panel i is built into the map display device 10, but the touch panel 1 may be externally attached to the map display device 10.

The display processor 2 has a function of generating an image signal for displaying an image on the touch panel 1. The display processor 2 further includes a map display unit 2a that causes the touch panel 1 to display a map, and a scrolling-screen display unit 2b that causes the touch panel 1 to display a scrolling screen for a user to scroll a map displayed on the touch panel 1 (scrolling). The details of the scrolling screen will be described later.

The operation analyzer 3 has a function of recognizing a user operation performed on the touch panel 1 and analyzing the contents of the operation. The controller 6 is capable of controlling the display processor 2 in accordance with the contents of the operation analyzed by the operation analyzer 3 and transitioning the display contents of the touch panel 1. For example, when the user scrolls a map displayed on the touch panel 1, the controller 6 controls the display processor 2 to scroll the map displayed on the touch panel 1.

The storage 4 stores data (map information) regarding a map to be displayed on the touch panel 1 by the map display unit 2a, and information (POI information) regarding the position and type of each POI existing on the map. The map display device 10 of the present embodiment can register specific types of POIs and areas as “significant objects” and types of areas that are considered not to include significant objects as “insignificant areas.” Thus, the storage 4 further stores significant-object information that indicates the registered significant objects, and insignificant-area information that indicates the registered insignificant areas. Examples of the significant objects include temples, schools, urban areas, sightseeing areas, and borders between countries. Examples of the insignificant areas include the sea, mountains, deserts, extensive farming areas. Note that the insignificant-area information is not used in Embodiment 1 but is used in Embodiment 2 onwards.

The current-position acquiring unit 5 has a function of calculating the current position of the map display device 10 on the basis of a GPS signal received by a global positioning system (GPS) receiver, which is not shown. When the map display device 10 is installed in a vehicle, the current-position acquiring unit 5 preferably reflects sensor information (e.g., the speed and travel direction of the vehicle) obtained from sensors of the vehicle (also referred to as “own vehicle”) in the calculation of the current position of own vehicle in order to calculate a more accurate position of own vehicle.

In the present embodiment, the map display device 10 is assumed to be installed in a vehicle. The map display device of the present invention is, however, applicable to not only on-board devices such as navigation systems but also portable devices such as smartphones.

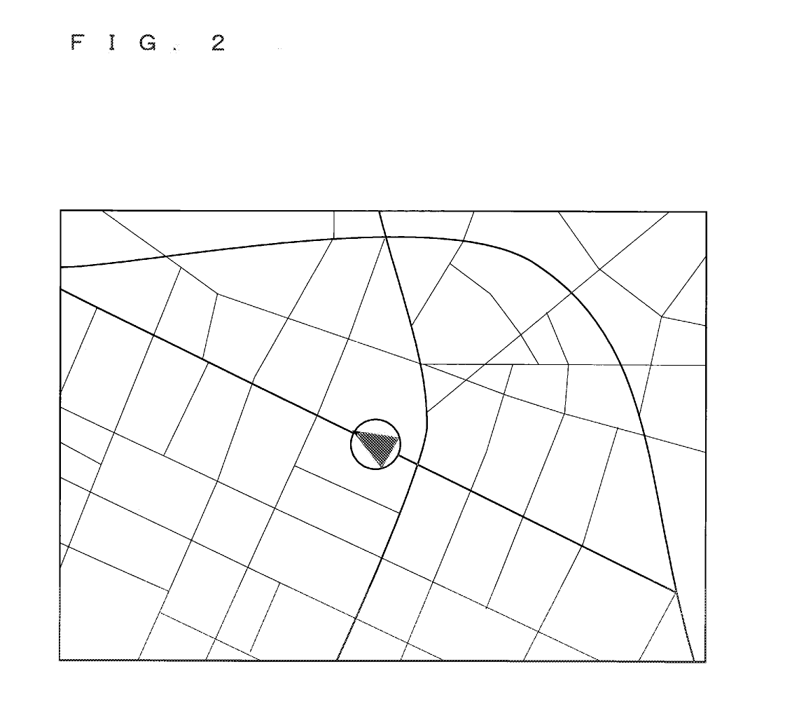

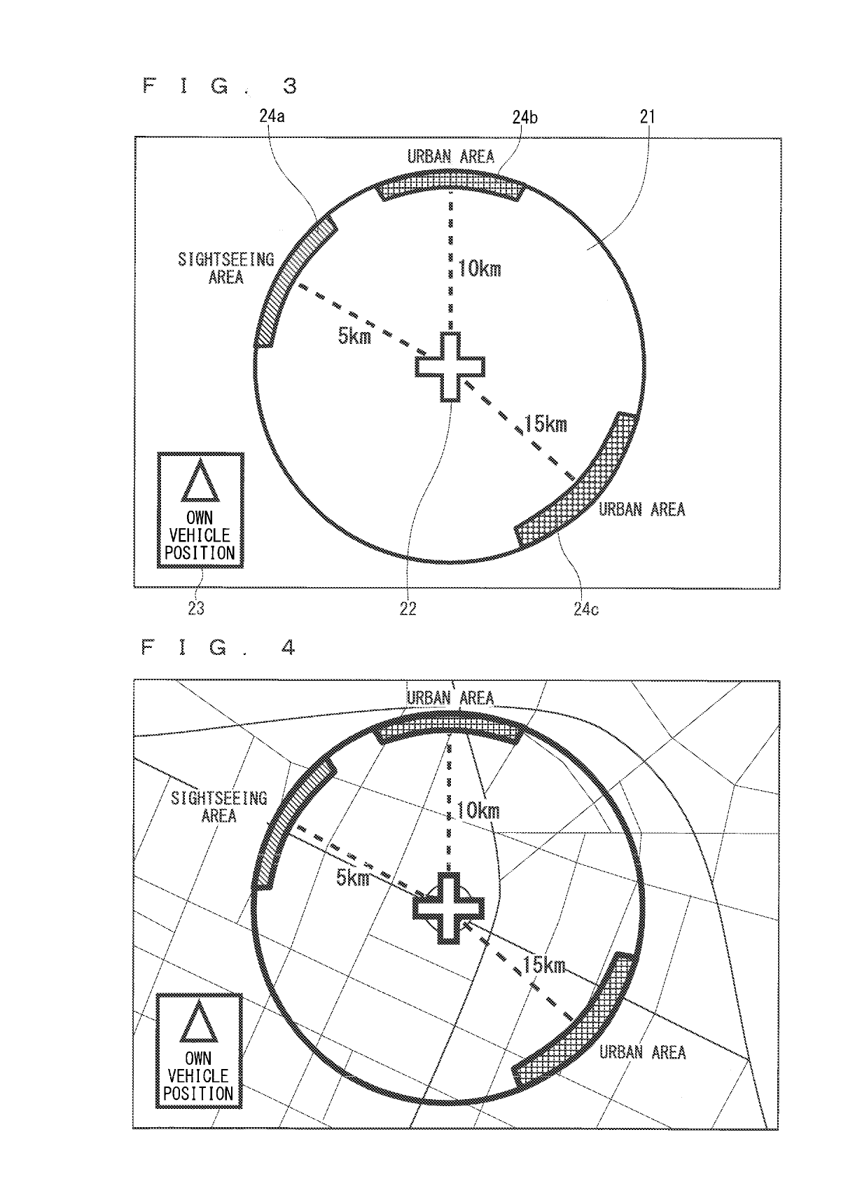

The details of the display processor 2 will now be described. The map display unit 2a of the display processor 2 causes the touch panel 1 to display a map such as illustrated in FIG. 2. The icon displayed in the center in FIG. 2 indicates the position and travel direction of own vehicle. On the other hand, the scrolling-screen display unit 2b of the display processor 2 causes the touch panel 1 to display a scrolling screen such as illustrated in FIG. 3. In actuality, the scrolling screen is displayed superimposed on the map as illustrated in FIG. 4.

The scrolling screen includes a direction designation region 21, a cursor 22, a vehicle-position display icon 23, and significant-object icons 24a to 24c as illustrated in FIG. 3. As can be seen from FIG. 4, portions of the scrolling screen other than the contour of the direction designation region 21, the cursor 22, the vehicle-position display icon 23, and the significant-object icons 24a to 24c are transparent and the map that is underneath can be seen through the scrolling screen.

The direction designation region 21 is a region for a user to designate the direction of scrolling the map with a touch operation. While the direction designation region 21 in FIG. 3 is circular, the direction designation region 21 may have an arbitrary shape such as being elliptical or polygonal. The cross-shaped cursor 22 is displayed in the center of the direction designation region 21, allowing the user to operate the cursor 22 within the direction designation region 21 to designate the direction of scrolling the map. The cursor 22 may also have an arbitrary shape.

The amount (distance) of scrolling the map is determined according to how the user operates the cursor 22. For example, when the cursor 22 is moved by being dragged, the map is scrolled by the same amount and in the same direction as the cursor 22 has moved (after the scrolling, the cursor 22 returns to the center of the direction designation region 21). When the cursor 22 is flicked, the map is automatically scrolled for only a fixed period of time in the direction the cursor has been flicked and at a speed in accordance with the speed of flicking.

The vehicle-position display icon 23 is for returning the map displayed on the touch panel 1 to a map centered on the position of own vehicle. That is, when the vehicle-position display icon 23 is tapped, the map automatically scrolls (or jumps) to the position of own vehicle.

The significant-object icons 24a to 24c indicate the directions in which registered significant objects exist, and are displayed on the outer periphery of the direction designation region 21. The center of the direction designation region 21 corresponds to a reference point defined on the map being displayed, and the direction from the center of the direction designation region 21 to each significant-object icon corresponds to the direction in which the corresponding significant object exists as viewed from the reference point. In the present embodiment, a central point on the map being displayed is defined as the reference point. For example, when the map is displayed in north-up orientation and a significant-object icon is displayed on the upper outer periphery of the direction designation region 21, this indicates that the significant object indicated by that significant-object icon exists to the north as viewed from the central point (reference point) on the map being displayed. Significant-object icons are displayed in different forms (e.g., colors, patterns, and shapes) depending on the type of significant objects indicated by the significant-object icons so that the user can identify the types of significant objects indicated by the significant-object icons.

In the example in FIG. 3, the significant-object icon 24a indicates that a sightseeing area exists to the north-west from the central point on the map being displayed. The significant-object icon 24b indicates that an urban area exists to the north from the central point on the map being displayed. The significant-object icon 24c indicates that another urban area exists to the south-east from the central point on the map being displayed. While FIG. 3 illustrates an example of the case where the scrolling screen also displays the distances from the reference point to the significant objects indicated by the significant-object icons 24a to 24c and text information (e.g., “Sightseeing Area” or “Urban Area”) that indicates the types of significant objects indicated by the significant-object icons 24a to 24c, the display of such information may be omitted. Alternatively, text information that indicates specific names of the significant objects (e.g., the names of facilities or the names of cities) may be displayed, instead of the text information indicating the types of significant objects.

The significant-object icons 24a to 24c can also be used in an operation for moving the map displayed on the touch panel 1 to a point of each significant object. That is, when one of the significant-object icons 24a to 24c is selected by being tapped, the map automatically scrolls (or jumps) to the point of the significant object indicated by the selected significant-object icon.

As described previously, significant objects displayed as significant-object icons on the scrolling screen are specific types of POIs and areas that have been registered in advance. The types of POIs and areas to be registered as significant objects may be fixed or may be arbitrarily set by the user. Also, POIs and areas in categories that are searched for by the user using a search function of the map display device 10 may be automatically registered as significant objects.

Significant objects to be displayed as significant-object icons on the scrolling screen are preferably limited to those that exist within a practical range of scrolling the map (e.g., a range of up to 100 km away from the reference point). This is because if significant objects within a range that is wider than necessary are displayed as significant-object icons, almost the entire outer periphery of the direction designation region 21 may be filled with the significant-object icons, possibly making it difficult to grasp the existence of significant objects located nearby. The range of significant objects to be displayed as significant-object icons may be arbitrarily set by the user or may be automatically set according to the scale of the map being displayed.

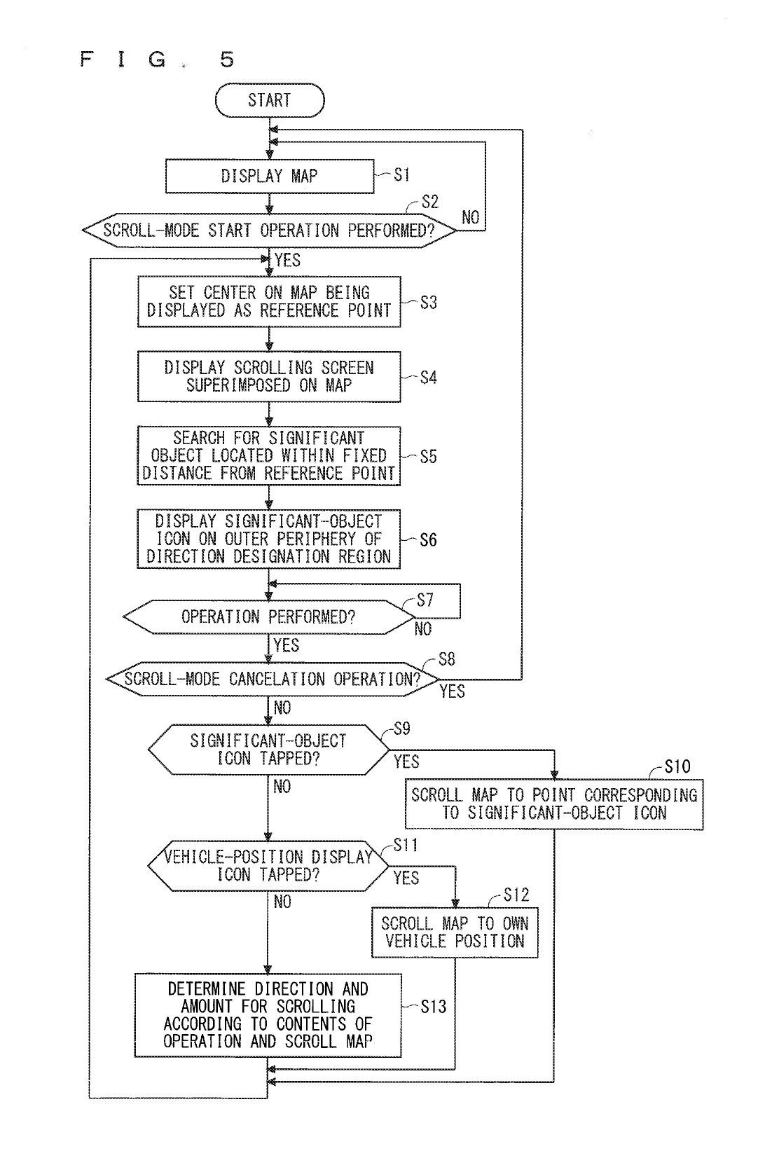

FIG. 5 is a flowchart of operations performed by the map display device 10. The operations of the map display device 10 will now be described with reference to FIG. 5.

When the map display device 10 is started up, the controller 6 controls the map display unit 2a of the display processor 2 to cause the touch panel 1 to display a map such as illustrated in FIG. 2 (step S1). The map displayed at the start-up is, for example, a map centered on the position of own vehicle, which is acquired by the current-position acquiring unit 5. While the map is displayed on the touch panel 1, the controller 6 monitors whether or not a user has performed an operation (scroll-mode start operation) that requests the start of an operation mode in which the map is scrolled (step S2). The map continues to be displayed while no scroll-mode start operation has been performed (NO in step S2).

When the user has performed the scroll-mode start operation (YES in step S2), the controller 6 sets the central point on the map that is being displayed at that time (corresponds to the position of own vehicle if immediately after the start-up) as a reference point (step S3). The controller 6 then controls the scrolling-screen display unit 2b of the display processor 2 to cause the scrolling screen including the direction designation region 21, the cursor 22, and the vehicle-position display icon 23 to be displayed superimposed on the map on the touch panel 1 (step S4).

Simultaneously with this, the controller 6 searches for significant objects located within a fixed distance from the reference point with reference to the map information, the POI information, and the significant-object information that are stored in the storage 4 (step S5), and displays significant-object icons corresponding to the found significant objects on the outer periphery of the direction designation region 21 (step S6). At this time, the significant-object icons are displayed at positions corresponding to the directions in which the significant objects exist as viewed from the reference point. Consequently, a screen such as illustrated in FIG. 4 is displayed on the touch panel 1. Thereafter, the controller 6 waits for a user operation (step S7).

When a user operation has been received (YES in step S7), the controller 6 performs operations according to the contents of the user operation. For example, when the user operation is an operation that requests the cancellation of the scroll mode (scroll-mode cancellation operation) (YES in step S8), the scroll mode ends and the procedure returns to step S1 in which a normal map that does not include the scrolling screen is displayed.

When the user operation is tapping on a significant-object icon (NO in step S8 and YES in step 9), the controller 6 controls the map display unit 2a to scroll the map to a point corresponding to the tapped significant-object icon (step S10). When the user operation is tapping on the vehicle-position display icon 23 (NO in steps S8 and S9 and YES in step S11), the map is scrolled to a point corresponding to the position of own vehicle (step S12). When the user operation is none of the above-described operations (NO in steps S8, S9, and S11), the direction and amount (distance) for scrolling the map are determined according to the contents of the user operation (e.g., dragging or flicking of the cursor 22), and the map is scrolled (step S13).

The procedure returns to step S3 after scrolling the map. In step S3 this time, the center of the map that is displayed after scrolling is set as a new reference point. The operations of steps S3 to S13 are repeatedly executed until the scroll mode is cancelled (until YES in step S8).

The present embodiment allows the user, when scrolling a map via the scrolling screen, to know in advance the directions in which significant objects exist as viewed from the central point (reference point) on the map being displayed. This achieves the effect of saving the user unnecessary scrolling (scrolling in directions in which no significant objects exist).

Variations

From the viewpoint of usability and visibility of the map, the scrolling screen does not necessarily have to display all significant objects existing within a fixed distance from the reference point as significant-object icons. For example, display of significant-object icons of significant objects that are included in the map being displayed on the touch panel 1 may be omitted because the existence of these significant objects can be recognized from the map. In this case, the scrolling screen displays only significant-object icons of significant objects that are located out of the range of the map being displayed.

Display of significant-object icons may also be omitted for significant objects that are of the same type as the significant objects included within the range of map being displayed on the touch panel 1. In this case, the scrolling screen displays only significant-object icons that correspond to significant objects of types that do not exist within the range of the map being displayed.

When the map is automatically scrolled by flicking the cursor 22, the scroll speed may be changed depending on whether or not the scroll direction is a direction in which a significant object exists (the length of time for automatic scrolling may be fixed). For example, if the speed of scrolling in a direction in which no significant object exists is increased to be higher than the speed of scrolling in a direction in which a significant object exists, usability is improved because the user can quickly skip the area where no significant objects exist on the map. Alternatively, the scroll speed may be changed according to the distance from the area on the map being displayed to a significant object. For example, the scroll speed may be increased as the distance of the area on the map from a significant object increases.

Significant-object icons may be displayed only when necessary on the scrolling screen. For example, significant-object icons may be displayed when the user brings an indicator (such as a finger of the user) for scrolling the map close to the touch panel 1. This ensures the visibility of the map being displayed under the scrolling screen. It is, however, necessary to provide the map display device 10 with a sensor or the like for detecting the approach of the indicator.

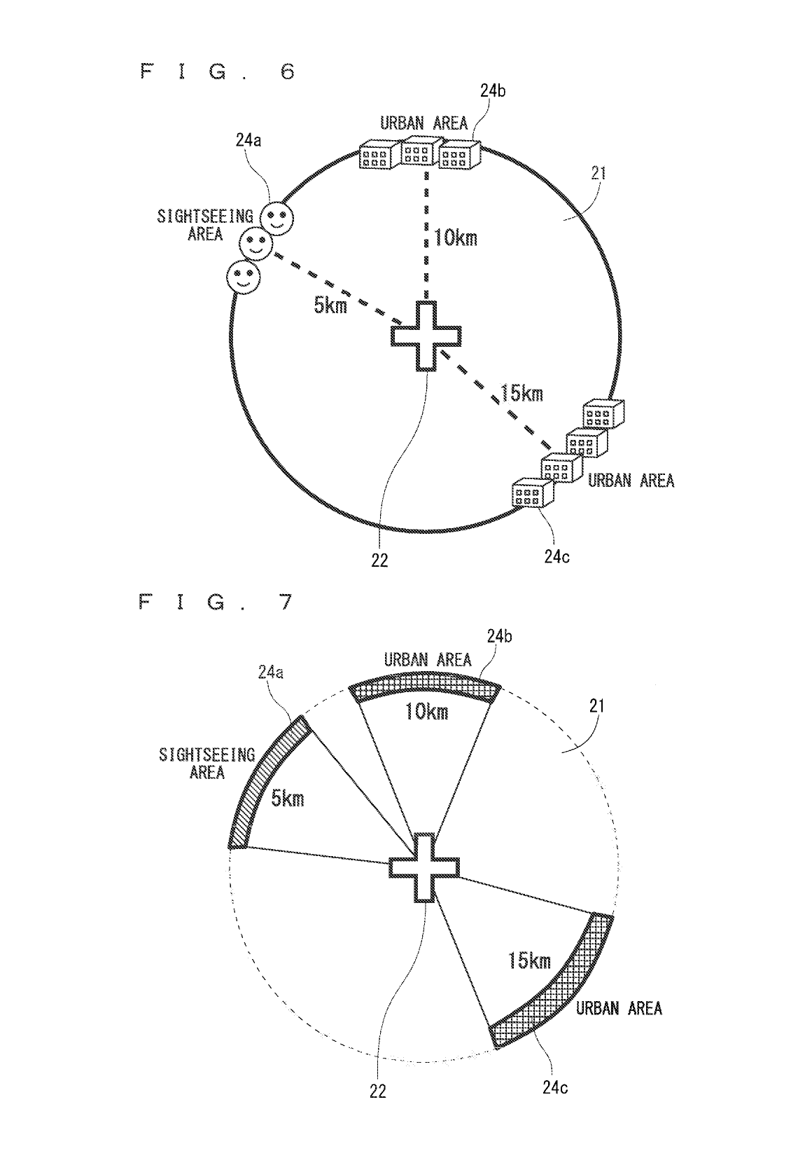

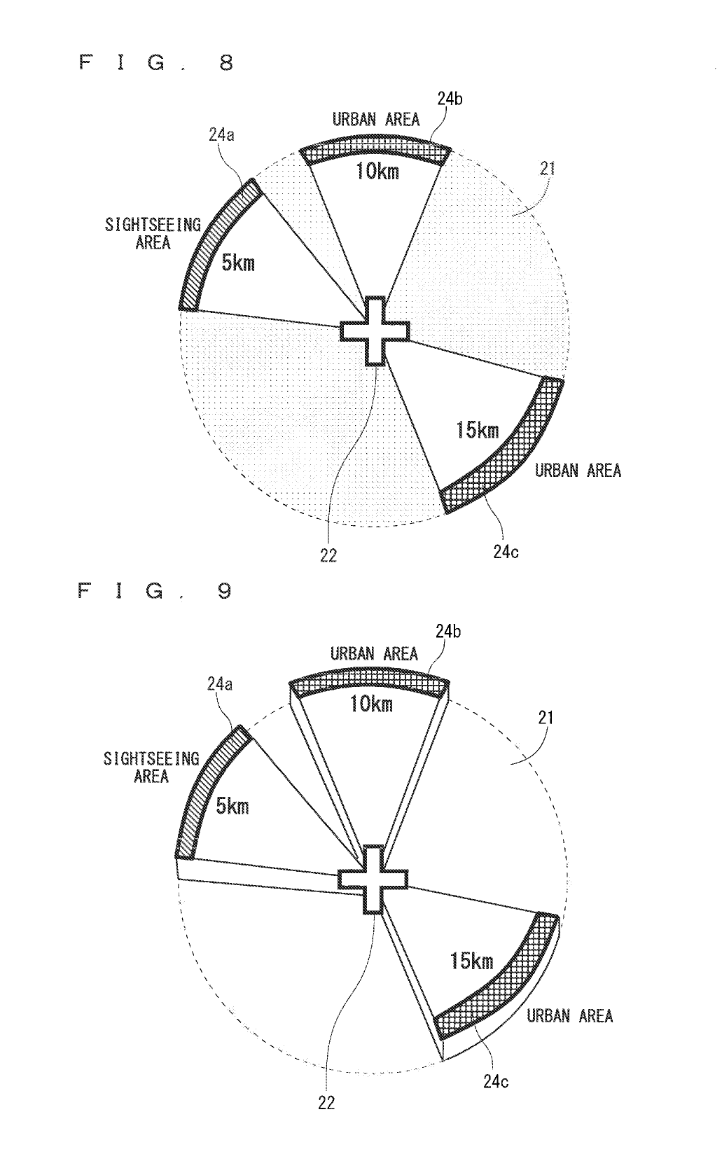

Significant-object icons may be arbitrarily designed, examples of which include significant-object icons having illustrative designs and significant-object icons having three-dimensional designs as illustrated in FIG. 6. Also, a significant-object icon indicating the border between countries may be a significant-object icon designed with the national flag of the country on the other side of the border.

The configuration of the direction designation region 21 of the scrolling screen is not limited to that illustrated in FIG. 3, and for example, display of a graphic (here, a cle) indicating the contour of the direction designation region 21 may be omitted.

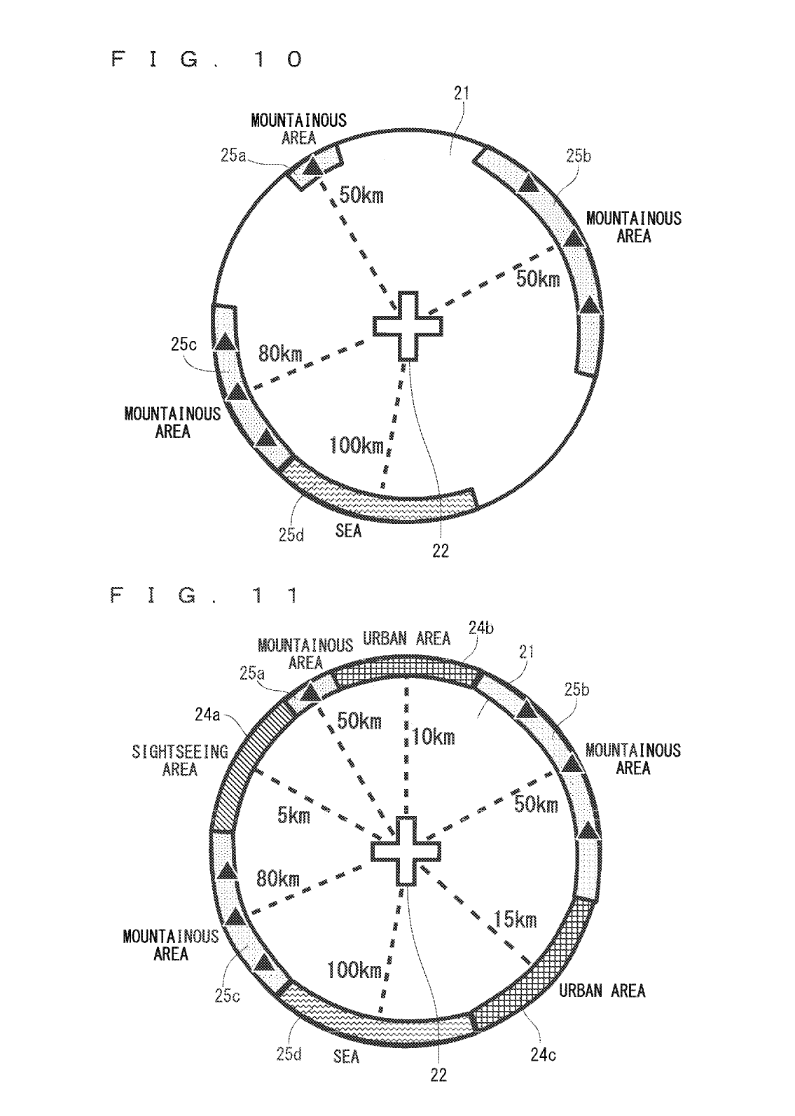

Also, pie-shaped sectors using arcs as significant-object icons may be displayed as illustrated in FIG. 7. Furthermore, the pie-shaped sectors using arcs as significant-object icons in the direction designation region 21 may be made transparent, and portions outside the pie-shaped sectors may be made translucent or subjected to blur processing (blurring). The transparency of the translucent portions or the pixel values of the blurred portions may be changed according to the distance from the area on the map being displayed to the significant objects. In the case of displaying the significant-object icons of a plurality of significant objects located at different distances, the transparency or the pixel values used in the blur processing may be set based on the distance to the closest significant object. Alternatively, the priority order may be set in advance in accordance with the types of significant objects, and the transparency or the pixel values used in the blur processing may be set based on the distance to the significant object with the highest priority. For example, it is conceivable to reduce the transparency as the distance of the area on the map being displayed from the significant object increases. Also, the pie-shaped sectors using arcs as significant-object icons may be displayed three-dimensionally so that the portions outside the pie-shaped sectors looks like they are recessed as illustrated in FIG. 9.

### Embodiment 2

In Embodiment 1, significant-object icons indicating the existence of significant objects are displayed on the outer periphery of the direction designation region 21 of the scrolling screen, whereas Embodiment 2 describes a case in which insignificant-area icons indicating the existence of insignificant areas are displayed, instead of the significant-object icons. Insignificant areas are registered in advance as areas of types that are considered not to include significant objects, examples of which include the sea, mountains, deserts, and extensive farming areas. The types of areas to be registered as insignificant areas may be fixed or may be arbitrarily set by the user.

In the map display device 10 of Embodiment 2, when the scroll mode is started and the scrolling screen is displayed on the touch panel 1, the controller 6 searches for insignificant areas existing within a fixed distance from the reference point with reference to the map information and the insignificant-area information that are stored in the storage 4, and displays insignificant-area icons corresponding to the found insignificant areas on the outer periphery of the direction designation region 21. The insignificant-area icons are displayed in different forms (e.g., colors, patterns, and shapes) depending on the types of insignificant areas so that the user can identify the types of insignificant areas.

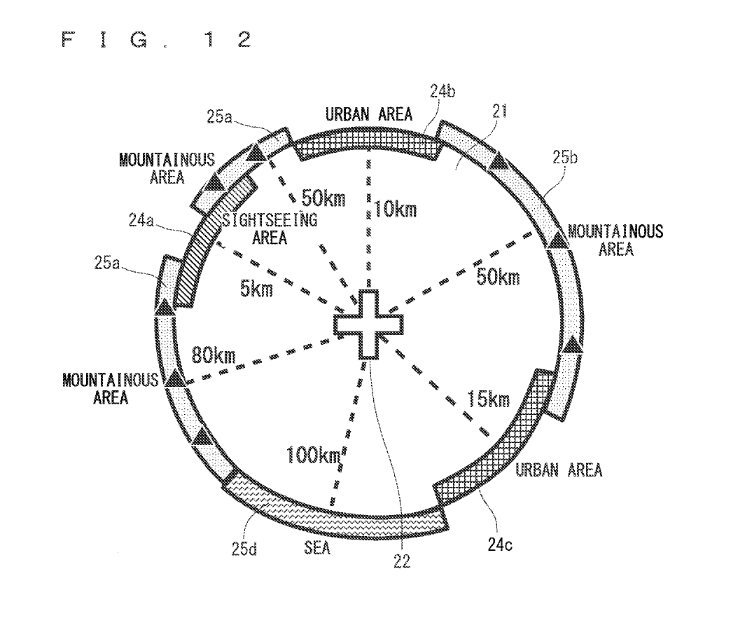

FIG. 10 illustrates a configuration of the direction designation region on the scrolling screen according to Embodiment 2. Although not shown, the scrolling screen in the present embodiment also includes the vehicle-position display icon 23 and is displayed superimposed on the map.

The central point on the map being displayed is assumed to be defined as a reference point, and when the map is displayed in north-up orientation, insignificant-area icons 25a to 25c in FIG. 10 respectively indicate the existence of mountainous areas to the north-northwest, to the south-west, and to the north-east from the central point on the map being displayed. An insignificant-area icon 25d indicates the existence of the sea to the south from the central point on the map being displayed. While FIG. 10 illustrates an example of the case where the scrolling screen also displays the distances from the reference point to the insignificant areas indicated by the insignificant-area icons and text information (e.g., “Mountainous Area” or “Sea ”) that indicates the types of insignificant areas indicated by the insignificant-area icons, the display of such information may be omitted. Alternatively, text information that indicates specific names of the insignificant areas (e.g., the names of mountainous areas or the names of oceans) indicated by the insignificant-area icons may be displayed.

The present embodiment allows the user, when scrolling the map via the scrolling screen, to know in advance the directions in which insignificant areas exist as viewed from the center of the map being displayed. This achieves the effect of saving the user unnecessary scrolling (scrolling in directions in which no significant objects exist).

### Embodiment 3

In Embodiment 3, both significant-object icons and insignificant-area icons are displayed on the scrolling screen. FIG. 11 illustrates a configuration of the direction designation region on the scrolling screen according to Embodiment 3. Although not shown, the scrolling screen in the present embodiment also includes the vehicle-position display icon 23 and is displayed superimposed on the map.

Displaying both significant-object icons and insignificant-area icons on the scrolling screen allows the user, when scrolling the map via the scrolling screen, to know in advance the directions in which significant objects exist and the directions in which insignificant areas exist, using the center of the map being displayed as a reference. That is, Embodiment 3 can achieve the effects of Embodiments 1 and 2 and can further save the user unnecessary scrolling (scrolling in directions in which no significant objects exist).

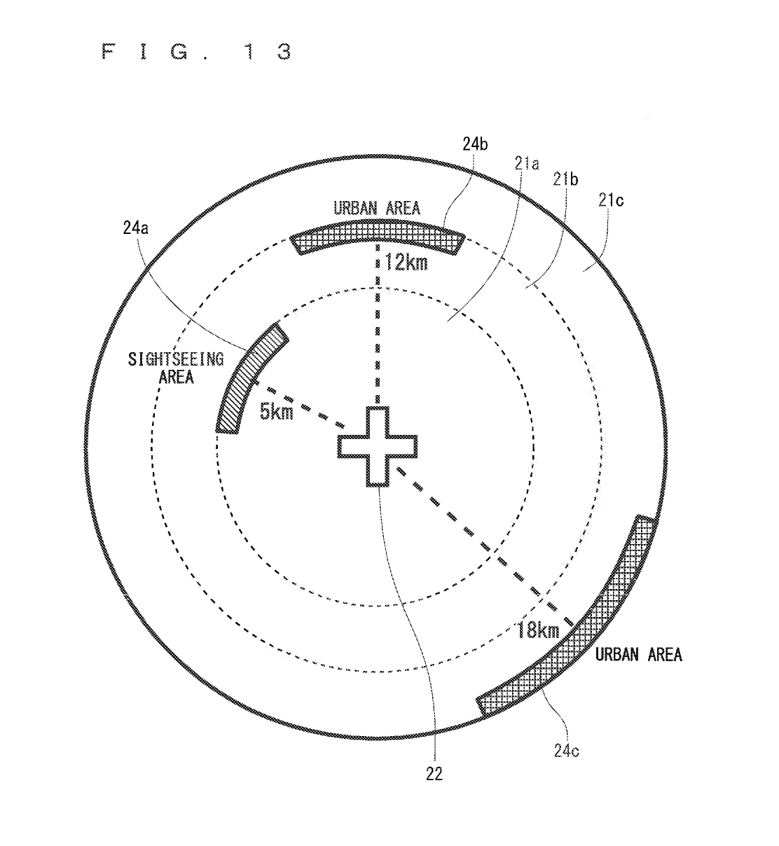

While the examples of the direction designation region 21 described thus far show cases where the directions indicated by the significant-object icons 24a to 24c and the insignificant-area icons 25a to 25d do not overlap, cases are also conceivable in which a plurality of significant objects exist in the same direction or a significant object exists in front of an insignificant area. In such cases, display positions of icons may be appropriately shifted so that the icons do not overlap with one another as illustrated in FIG. 12.

### Embodiment 4

In Embodiment 4, a plurality of direction designation regions having the same central position and different sizes are displayed on the scrolling screen. Then, significant-object icons or insignificant-area icons are displayed on the outer periphery of any of the plurality of direction designation regions in accordance with the distance from the reference point.

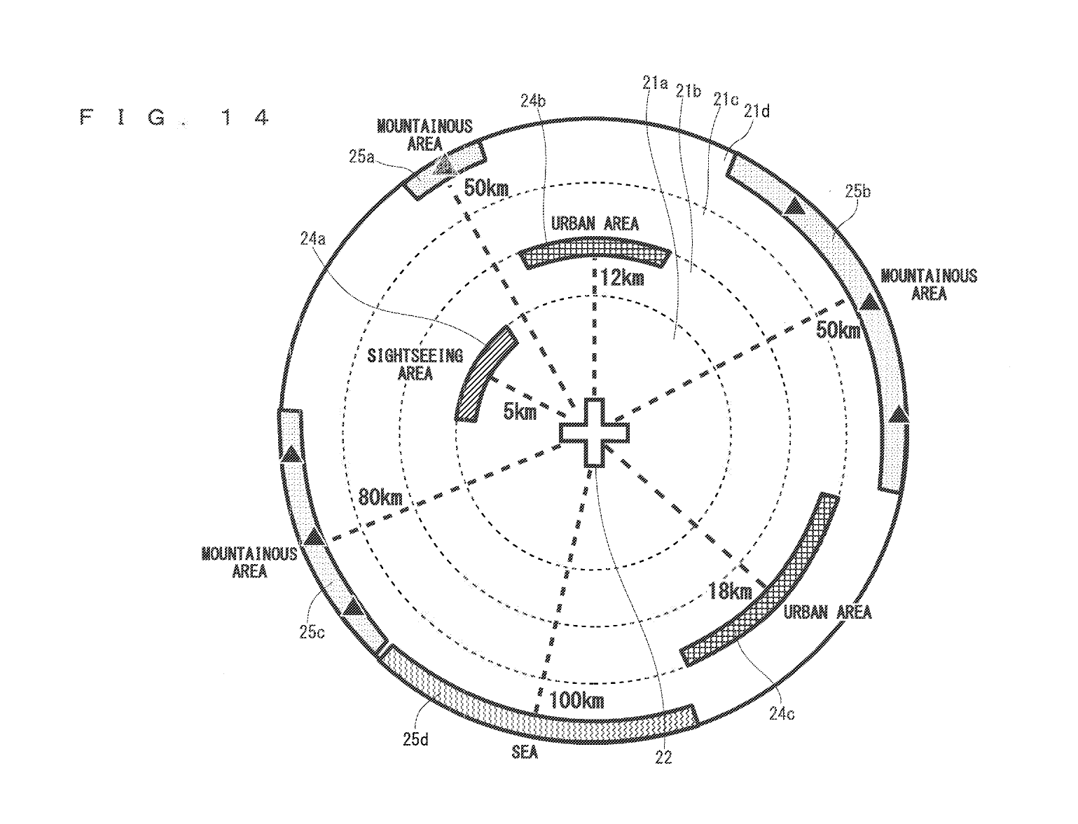

FIG. 13 illustrates a configuration of the direction designation regions on the scrolling screen according to Embodiment 4. This scrolling screen includes three direction designation regions 21a to 21c having the same central position and different sizes. Here, significant-object icons of significant objects that are located within a range of less than 10 km away from the reference point are displayed on the outer periphery of the innermost direction designation region 21a. Also, significant-object icons of significant objects that are located within a range of 10 km or more and less than 15 km away from the reference point are displayed on the outer periphery of the direction designation region 21b located on the outside of the direction designation region 21a. Moreover, significant-object icons of significant objects that are located within a range of 15 km or more away from the reference point are displayed on the outer periphery of the outermost direction designation region 21c.

Thus, in FIG. 13, the significant-object icon 24a indicating a sightseeing area located 5 km away from the reference point is displayed on the outer periphery of the direction designation region 21a. The significant-object icon 24b indicating an urban area located 12 km away from the reference point is displayed on the outer periphery of the direction designation region 21b. The significant-object icon 24c indicating a sightseeing area located 18 km away from the reference point is displayed on the outer periphery of the direction designation region 21c.

While FIG. 13 illustrates an example in which only the significant-object icons are displayed on the scrolling screen, examples are also possible in which only insignificant-area icons are displayed as in Embodiment 2 and in which both significant-object icons and insignificant-area icons are displayed as in Embodiment 3. For example, FIG. 14 illustrates an example of the case in which both significant-object icons and insignificant-area icons are displayed.

In FIG. 14, icons indicating significant objects or insignificant areas that are located within a range of less than 10 km away from the reference point are displayed on the outer periphery of the innermost direction designation region 21a. Also, icons indicating significant objects or insignificant areas that are located within a range of 10 km or more and less than 15 km away from the reference point are displayed on the outer periphery of the direction designation region 21b located on the outside of the direction designation region 21a. Moreover, icons indicating significant objects or insignificant areas that are located within a range of 15 km or more and less than 30 km away from the reference point are displayed on the outer periphery of the direction designation region 21c located on the outside of the direction designation region 21b. In addition, icons indicating significant objects or insignificant areas that are located within a range of 30 km or more are displayed on the outer periphery of the outermost direction designation region 21d.

Thus, in FIG. 14, the significant-object icon 24a indicating a sightseeing area located 5 km away from the reference point is displayed on the outer periphery of the direction designation region 21a, the significant-object icon 24b indicating an urban area located 12 km away from the reference point is displayed on the outer periphery of the direction designation region 21b, and the significant-object icon 24c indicating a sightseeing area located 18 km away from the reference point is displayed on the outer periphery of the direction designation region 21c. Moreover, the insignificant-area icons 25a to 25c indicating mountainous areas located at points distanced 30 km or more from the reference point and the insignificant-area icon 25d indicating the sea are displayed on the outer periphery of the direction designation region 21d.

Embodiment 4 can achieve the effect of allowing the user to intuitively grasp the distances from the reference point to the significant objects and the insignificant areas.

It should be noted that the present invention can be implemented by freely combining the above embodiments or by making modifications or omissions to the embodiments as appropriate within the scope of the present invention.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1 Touch panel

2 Display processor

2a Map display unit

2b Scrolling-screen display unit

3 Operation analyzer

4 Storage

5 Current-position acquiring unit

6 Controller

10 Map display device

21, 21a-21d Direction designation region

22 Cursor

23 Vehicle-position display icon

24a-24c Significant-object icon

25a-25d Insignificant-area icon

1. A map display device comprising:
a computer to execute a program; and
a memory to store the program which, when executed by the computer, results in performance of steps comprising,
causing a display device to display a map;
causing said display device to display a scrolling screen that includes a direction designation region for a user to designate a direction of scrolling the map; and
causing the map being displayed to scroll in the direction designated by the user using said scrolling screen, wherein
a center of said direction designation region corresponds to a reference point defined on the map being displayed on said display device, and
said map display device causes an icon that indicates existence or absence of a predetermined significant object in each direction viewed from said reference point to be displayed on an outer periphery of said direction designation region at a position corresponding to the direction.

2. The map display device according to claim 1, wherein
said icon includes a significant-object icon that indicates the existence of a significant object.

3. The map display device according to claim 2, wherein
said significant-object icon is displayed in a form that differs according to a type of significant object.

4. The map display device according to claim 2, wherein
said scrolling screen further includes display of a distance to the significant object indicated by said significant-object icon.

5. The map display device according to claim 2, wherein
when said significant-object icon is selected by a user, said map display device causes the map to automatically scroll or jump to a point of the significant object corresponding to the selected significant-object icon.

6. The map display device according to claim 1, wherein
said icon includes an insignificant-area icon that indicates an insignificant area in which no significant objects exist.

7. The map display device according to claim 6, wherein
said insignificant-area icon is displayed in a form that differs according to a type of insignificant area.

8. The map display device according to claim 6, wherein
said scrolling screen further includes display of a distance to the insignificant area indicated by said insignificant-area icon.

9. The map display device according to claim 1, wherein
said map display device does not display said icon of a significant object that is located a fixed distance or more away from said reference point.

10. The map display device according to claim 1, wherein
said map display device does not display said icon of a significant object that exists within a range of the map being displayed on said display device.

11. The map display device according to claim 1, wherein
said map display device does not display said icon of a significant object of the same type as a significant object that exists within a range of the map being displayed on said display device.

12. The map display device according to claim 1, wherein
said scrolling screen includes a plurality of direction designation regions having the same central position and different sizes, and
said map display device causes said icon to be displayed on an outer periphery of one of said plurality of direction designation regions in accordance with a distance from said reference point to a point indicated by said icon.

13. The map display device according to claim 1, wherein
said map display device changes a speed of scrolling the map in accordance with whether or not the direction of scrolling the map is a direction in which a significant object exists.

14. The map display device according to claim 1, wherein
said map display device changes a speed of scrolling the map in accordance with a distance to a significant object from an area on the map being displayed on said display device.

15. The map display device according to claim 1, wherein
said map display device automatically displays said scrolling screen upon detecting an approach of an indicator toward said display device, said indicator being for the user to scroll the map.

16. A map display method comprising:
causing a display device to display a map;
causing said display device to display a scrolling screen that includes a direction designation region for a user to designate a direction of scrolling the map; and
causing the map being displayed to scroll in the direction designated by the user using said scrolling screen, wherein
a center of said direction designation region corresponds to a reference point defined on the map being displayed on said display device, and
when said scrolling screen is caused to be displayed, an icon that indicates existence or absence of a predetermined significant object in each direction viewed from said reference point is caused to be displayed on an outer periphery of said direction designation region at a position corresponding to the direction.
